(19) United States
(12) Patent Application Publication
(10) Pub. No.: US 2024/0280668 A1
(43) Pub. Date: Aug. 22, 2024

(54) A DRONE DETECTION DEVICE AND METHOD THEREOF

(71) Applicant: THE SECRETARY OF STATE FOR DEFENCE, Salisbury, Wiltshire (GB)

(72) Inventor: Andrew Paul Speed, Salisbury (GB)

(21) Appl. No.: 18/560,250

(22) PCT Filed: May 10, 2022
(86) PCT No.: PCT/IB2022/054337

§ 371 Date: Nov. 10, 2023

(30) Foreign Application Priority Data
May 13, 2021 (GB) 2106807.7

(51) Int. Cl. G01S 7/41; H04W 84/12

(52) U.S. Cl. CPC G01S 7/415; H04W 84/12

(57) ABSTRACT

A computer implemented method of detecting a drone 200 from a micro-Doppler signature. The method comprising the steps of controlling a computer processor to perform the steps of: receiving signal data of a re-radiated signal 303 from a wireless communication device 212 on a drone 200 following stimulation of the wireless communication device 212 by a predetermined signal 301. Applying a detection operation to the re-radiated signal 303 data to detect a micro-Doppler signature. Wherein the detection operation comprises applying a predetermined criterion for distinguishing at least one known micro-Doppler signature of a wireless communication device on a drone, from at least one known signature of a wireless communication device that is not on a drone. Declaring the detection of a drone 200 in response to a positive detection based on the predetermined criterion. Characterised in that: the re-radiated signal 303 comprises fundamental component 400 and harmonic components 410/420. The frequency of the harmonic components 410/420 being substantially N integer multiples of the fundamental component 400; wherein N is greater than 1. The computer processor performs the further steps of: extracting harmonic component 410/420 data from the re-radiated signal 303 data; and then applying the detection operation to the harmonic component 410/420 data. The method provides higher confidence and fidelity in detection of a drone than approaches of the prior art.

### TECHNICAL FIELD OF THE INVENTION

The invention relates to radar, in particular a radar apparatus suitable for detecting a drone from a radar signature. The invention extends to a related method.

### BACKGROUND TO THE INVENTION

Drones are generally unmanned vehicles and could operate in the space, air, land or sea. Drones typically comprise wireless communications devices (i.e. a transmitter and/or a receiver) which may be used for various functions such as remote control, sensing, navigation or data communications. The drone wireless communications device may include Radio Frequency (RF) or radio wireless communications devices, such as typically found on radars, Electronic Warfare devices and radio communications devices. The misuse of these drones can pose a significant security threat and therefore there is an increasing need to detect and classify the drone such that it can be dealt with appropriately.

One approach to detecting drones is through a sensor such as a radar which transmits a signal and measures the reflection off the drone (known as the skin return). In some circumstances, the radar can detect the drone from the skin return which is a function of the drone's Radar Cross Section (RCS) however this can be unreliable in cluttered environments; particularly for small drones such as small commercial drones. Drones typically have a very small RCS and it therefore can be difficult to distinguish drones from radar clutter or even discriminate them from other small RCS targets such as a birds. Therefore using the RCS to detect a drone can provide low confidence results.

A more reliable approach for detecting drones is to analyse the micro-Doppler signature within the drones skin return. Micro-Doppler signatures are particular modulations on the skin return which are caused by micro motion of components on the drone. The frequency spectrum of this micro motion typically transpires as additional frequency components around the skin return. The frequency components may be fixed in frequency (relative to the skin return's centre frequency) or may sweep or oscillate across a small range of frequencies.

A coherent radar (which performs Doppler processing) can be used to measure the micro-Doppler signature on the skin return of a drone. In the case of a drone, the micro-Doppler signature may be caused by the rotation of a propeller blade which may appear as regular, high power, flashes covering a range of discrete or continuous Doppler frequencies. The range of Doppler frequencies and repetition period may be unique to a particular class of drone thereby providing further information which may be used for detection. A drone can be detected by matching the measured micro-Doppler signature to a database containing known micro-Doppler signatures corresponding to known classes of drones. However, the confidence in the accuracy of this detection will be limited; which may be insufficient for confirming detection of a particular drone.

The present invention seeks to improve the confidence in the detection of drones.

### SUMMARY OF THE INVENTION

According to a first aspect, the invention provides a computer implemented method of detecting a drone from a micro-Doppler signature, the method comprising the steps of controlling a computer processor to perform the steps of: receiving signal data of a re-radiated signal from a wireless communication device on a drone following stimulation of the wireless communication device by a predetermined signal; applying a detection operation to the re-radiated signal data to detect a micro-Doppler signature; wherein the detection operation comprises applying a predetermined criterion for distinguishing at least one known micro-Doppler signature of a wireless communication device on a drone, from at least one known signature of a wireless communication device that is not on a drone; declaring the detection of a drone in response to a positive detection based on the predetermined criterion characterised in that: the re-radiated signal comprises fundamental component and harmonic components; the frequency of the harmonic components being substantially n integer multiples of the fundamental component; wherein n is greater than 1; the computer processor performs the further steps of: extracting harmonic component data from the re-radiated signal data; and then applying the detection operation to the harmonic component data.

A micro-Doppler component on the harmonic of a re-radiated signal is a result of vibrational movement of the drone typically due to moving components such as electric motors (for the rotor blades) or other mechanical/electromechanical components. These micro-Doppler components provide a means for detecting the presence of a drone to provide higher confidence and fidelity of a positive detection.

Detecting a drone involves detecting the presence of a wireless communications device that is known to be integrated onboard the drone. The wireless communications device may include a Radio Frequency (RF) transmitter and/or a receiver. Generally the wireless communications device includes at least a receiver. Detection includes any sensor function including but not limited to the following functions: determining the presence of a drone, acquiring certain parameters of the drone such as range, Doppler, angle/bearing, tracking the drone in range, Doppler or angle and drone identification, recognition or classification. Detecting a drone using a micro-Doppler signature on a signal that has been re-radiated by a wireless communications device on the drone has the advantage that the re-radiated signal is not a function of the drone's RCS therefore the power received by the sensor is less dependent on the physical shape, size, design and/or configuration of the drone. This is particularly advantageous for detecting physically small drones or other low RCS drones. The micro-Doppler signature on the re-radiated signal may be caused by mechanical motion or vibrations within the drone for example the motion of the rotor blades or vibration of motors. The micro-Doppler signature may also be a result of resonating electronic components.

Detecting a drone is generally achieved by emitting a predetermined signal from at least one transmitter and measuring the signal re-radiated from a wireless communications device on the drone using at least one receiver. The transmitter(s) and receiver(s) may be monostatic, bistatic or multistatic and each may be space, ground or sea based. The transmitter(s) and/or receivers(s) could be a superheterodyne or heterodyne or any other type of known device.

Generally, specific types or models of target drones and associated onboard wireless communication devices will be determined a priori. Generally, the predetermined signal is developed a priori. Generally, the response of the known wireless communication device following illumination by the predetermined signal is determined a priori either through testing, simulation or modelling or any other means. Generally, the response of the wireless communication device upon receipt of the predetermined signal is to re-radiate a signal back towards the radar comprising a fundamental frequency (which is typically related to the frequency of the predetermined signal) and additional harmonic components. Generally, the harmonic components are imposed onto the re-radiated signal by non-linear components in the wireless communication device. Generally, the predetermined signal is in-band of the target wireless communication device to minimise loss through the wireless communication device and to maximise any gain such as antenna gain. Detection is achieved by illuminating the wireless communications device on the drone with the predetermined signal to induce/stimulate it to re-radiate a signal. This is in contrast to typical radar detection which aims to reflect a signal off the drone as a skin return. Typically, the re-radiated signal originates from a transmitter or receiver on the drone (which could be a superheterodyne or heterodyne or any other known type of wireless communication device); in particular, the receiver front-end (which includes the circuitry between the receive antenna up to the mixing stage). Generally, the wireless communications device is non-cooperative i.e. the primary functions of the wireless communications device are not typically influenced by the predetermined signal. The wireless communications device may be a Wifi®, GPS, GSM, LoRa or any other data communication device.

The transmitter is configured to transmit a predetermined signal. The predetermined signal is configured to provoke/induce/stimulate the drone wireless communications device to re-radiate a signal back to the sensor. The predetermined signal transmitted by the sensor could be any pulsed or Continuous Wave (CW) signal with any number or combinations of modulations and may be in-band or out-of-band of the passband of the drone wireless communications device. The predetermined signal may include modulations to achieve pulse compression to improve signal-to-noise, or communicate with or spoof the wireless communications device. Modulation may include frequency or phase shift key, or phase, frequency or amplitude modulations such as Linear Frequency Modulation or chirps.

Generally, the predetermined signal provokes a response from one or more components within the front-end of the receiver. This could include reflected signals due to impedance mismatches of specific components or other coupling paths within the front-end. It could also include non-linear responses due to compression or saturation of components. Components may include filters, attenuators, circulators, mixers, power amplifiers, diodes, couplers, power splitters, limiters, PCB and wiring as well as other well-known components. The re-radiated signal may be a low power level; however, generally it will be coherent with the predetermined signal. The frequency, phase, time and amplitude profile of the re-radiated signal will generally be unique to a class of front-end receivers.

Generally, the predetermined signal is transmitted by a harmonic radar. The harmonic radar is configured to stimulate the drone wireless communications device and process the harmonics of the re-radiated signal generated. Typically, the centre frequency of the re-radiated signal (the fundamental signal) is substantially the same frequency as the predetermined signal transmitted by the transmitter (although it may have a Doppler shift due to cruise or bulk motion of the drone). The re-radiated signal also comprises harmonics which are generally n integer multiples of the fundamental frequency; where n=2, 3 . . . N. Generally, the harmonics are generated due to non-linear response of components.

Generally, a micro-Doppler signature is imposed onto all elements of the re-radiated signal including the fundamental and the harmonics. Generally, a micro-Doppler signature on the fundamental is a result of any moving parts on the drone; including mechanically moving parts such as rotor blades and vibrations on the wireless communication device circuitry. The micro-Doppler signature on the harmonics are typically solely generated by micro motion/vibration of components in the wireless communication device. These vibrations may be caused by a moving, operational/active, mechanical or electromechanical components such as an electric motor and/or rotor blades. Since Doppler shift is proportional to the centre frequency of the carrier signal, the extent of the Doppler shift increases with each harmonic i.e. a larger Doppler shift is typically observed for higher order harmonics. Therefore the micro-Doppler signature is essentially magnified in frequency across harmonics. Advantageously, this magnification effect improves the accuracy and confidence of measurements on the micro-Doppler signature resulting in improved accuracy of sensor functions such as drone detection, acquisition, tracking and/or classification.

Harmonics also have the advantage that they are not obscured behind the skin return therefore reducing the complexity of the signal processing required to deinterleave the micro-Doppler signatures within the re-radiated signal and skin return.

Preferably, n is less than 10. Lower order harmonics are generally preferred since the power density of harmonics is typically inversely proportional to range (between the harmonic radar and the drone) to the power of 6 (i.e. an R⁻⁶ law) for the first harmonic. However, since the power density of the re-radiated signal is not proportional to the physical size/shape/design of the target drone and the re-radiated signal can potentially take advantage of any gain on the wireless communication device, a small RCS targets may still have strong harmonic returns.

The detection operation assesses a measured micro-Doppler signature and identifies (within a certain confidence) if it is representative of a wireless communication device on a drone. This could involve using unique features of such a micro-Doppler signature such as the number of frequency components, the amplitude profile across the frequency components or the separation (in frequency) between the frequency components.

Preferably, the detection operation comprises correlating a detected micro-Doppler signature with a database comprising known micro-Doppler signatures. The known micro Doppler signatures may be unique to a predetermined signal. The database may include a plurality of micro Doppler signatures corresponding to the same wireless communication device/drone but in response to a plurality of different predetermined signals. Generally correlation could involve cross-correlation or auto-correlation and a detection could be declared when the correlation function reaches a predetermined threshold. A database generally comprises a plurality of known micro-Doppler signatures corresponding to harmonic signals re-radiated by the wireless communication devices onboard known drones when active/operational and when illuminated by a predetermined signal.

Preferably, the detection operation comprises correlating detected micro-Doppler signatures across a plurality of harmonic components. Since micro Doppler signature is a function of centre frequency, comparing/correlating signatures across a plurality of harmonic components improves confidence in detection of a micro Doppler signature on a re-radiated signal.

Preferably, the computer processor is further configured to classify the drone. Generally, classification aims to distinguish the drone type from a number of sets (classes) using a priori knowledge. Optionally, classification involves providing a database containing a priori knowledge of known drone & wireless communications device classes. A priori knowledge may include number of rotor blades, rotor blade angular frequency, target wireless communications device vibration frequencies, target wireless communications device centre frequency, target wireless communications device bandwidth, amplitude profile of harmonic frequencies, target wireless communications device saturation power level. For example a class may include drone, mobile/cell phone, radar or a handheld UHF/VHF radio wireless communications device etc.

Preferably, the computer processor is further configured to identify the drone. Generally, drone identification indicates the drone's intent such as whether the drone is friendly or hostile. For example identification may include a particular type of military drone, Improvised Explosive Device (IED) or target engagement radar etc. The fidelity of the drone identification can be improved with higher fidelity a priori knowledge and integration of detection information from several sources.

Preferably, the wireless communication device is a wireless network based on the Institute of Electrical and Electronics Engineers IEEE 802.11 family of standards. Advantageous, the IEEE 802.11 protocol is widely utilised by drones in wireless communication devices such as Wifi®.

Preferably, the centre frequency of the predetermined signal is within the 2.4 GHz ISM band. Advantageously the 2.4 GHz ISM band is utilised by Wifi® according to the IEEE 802.11 protocol which is widely used by certain drones. In addition, this frequency band is particularly advantageous for detecting drones in complex multipath environments.

Optionally, the centre frequency of the predetermined signal is 1575.42 MHz within a bandwidth of 15.345 MHz. This is band is utilised by GPS L1 band.

Optionally, the centre frequency of the predetermined signal is 1227.6 MHz within a bandwidth of 11 MHz. This is band is utilised by GPS L2 band.

Optionally, the centre frequency of the predetermined signal is 1176.45 MHz within a bandwidth of 12.5 MHz. This is band is utilised by GPS L5 band.

Generally, the drone wireless communications device is designed to operate on a particular frequency band and the predetermined signal is in-band of the wireless communications device. Having a predetermined signal in-band of the wireless communications device has the advantage that the fundamental re-radiated signal is also in-band therefore may benefit from any gain provided by antennas on, and components in, the wireless communications device. Increased gain increases the power density of the re-radiated signal and consequently improves detection range and accuracy of the sensor.

Generally, the predetermined signal compresses or saturates the wireless communications device. During compression, there is a non-linear relationship between the power received and the power transmitted by the wireless communication device. Increasing the input power beyond compression saturates the wireless communications device such that output power does not increase with input power. Typically, a rich set of harmonics is generated when the wireless communications device is driven into compression or saturation. Advantageously, the micro-Doppler modulations on the resulting harmonics can be used to provide further confidence in detection, tracking, classifying, recognising and/or identifying of the drone.

Any feature in one aspect of the invention may be applied to any other aspects of the invention, in any appropriate combination. In particular device aspects may be applied to method or use aspects and vice versa. The invention extends to a device, method or use substantially as herein described, with reference to the accompanying drawings and examples.

In all aspects, the invention may comprise, consist essentially of, or consist of any feature or combination of features.

### BRIEF DESCRIPTION OF THE DRAWINGS

The present invention will now be described, purely by way of example, with reference to the accompanying drawings, in which:

FIG. 1 is an RF circuit diagram for a harmonic radar apparatus according to an embodiment of the invention;

FIG. 2 is a schematic view of a target drone;

FIG. 3 illustrates the harmonic radar apparatus of FIG. 1 and the drone of FIG. 2 in use;

FIG. 4 illustrates a spectrum of the signal returns from the drone;

FIG. 5 illustrates a spectrum of micro-Doppler signatures in the spectrum of FIG. 4.

The drawings are for illustrative purposes only and are not to scale.

### DETAILED DESCRIPTION

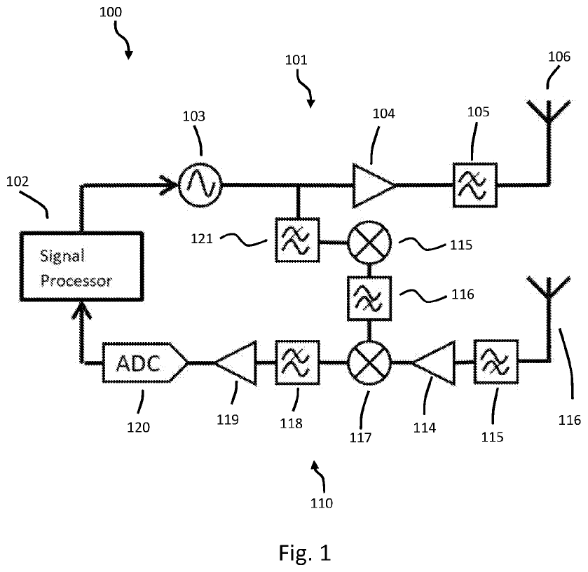

FIG. 1 is a schematic diagram of a radar apparatus 100 according to the invention.

A transmitter 101 comprises:
a signal processor 102 used to generate a baseband predetermined signal (not shown) typically designed (using a priori information) to stimulate a wireless communication device on a drone (not shown);
an oscillator 103 used to generate the predetermined signal (not shown) at analogue to a frequency F₁;
a Power Amplifier 104 used to set the Effective Isotropic Radiated Power (EIRP) of the predetermined signal. The EIRP is typically determined to ensure detection of a target drone (not shown) at a maximum detection range;
a Low Pass Filter (LPF) 105 having a cut off frequency F_{cut off}<F₂ to pass signals below the second harmonic;
a transmit antenna 106 configured to radiate the predetermined signal.

A receiver 110 comprises:
a receive antenna 116 configured to receive a signal re-radiated by a target drone (not shown);
a High Pass Filter (HPF) 115 having a cut off frequency F₁<F_{cut off}<Fₙ used to filter the fundamental frequency (at approximately F₁) and to pass harmonics Fₙ of the re-radiated signal;
a Low Noise Amplifier (LNA) 114 used to improve the sensitivity of the radar 100;
a downconverter comprising
   a LPF 121 having a cut off frequency of F_{cut off}>F₁;
   an integer n frequency multiplier 115 used to multiple the frequency provided by oscillator 103 to a chosen harmonic n having a frequency Fₙ;
   a HPF 116 having a cut off frequency F_{cut off}>Fₙ₋₁; and
   a mixer 117 used to downconvert the chosen harmonic n of the received signal to an Intermediate Frequency (IF);
a LPF 118;
an Intermediate Frequency (IF) amplifier 119;
an Analogue-to-Digital Converter (ADC) used to digitize the received signal for the signal processor 120;
a signal processor 102 configured to analyse the received signal and detect a micro-Doppler signature on a harmonic.

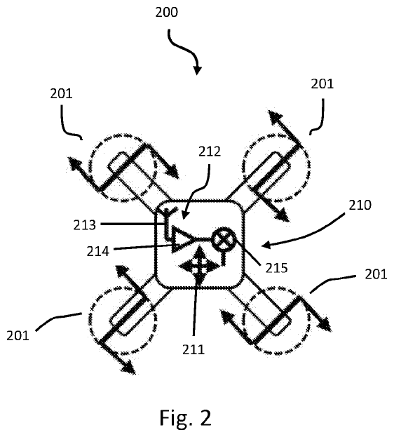

FIG. 2 is a schematic diagram of a target drone 200 comprising four rotor blades 201 in operation (the blades rotating in the direction of the associated arrows). The drone 200 comprises a body 210. When in operation (either during hover or cruise), the body 210 is subject to vibrational movement in all directions as indicated by arrows 211. The body 210 comprises a wireless communication device 212 which is a wireless network based on the Institute of Electrical and Electronics Engineers (IEEE) 802.11 family of standards such as Wifi®. The wireless communication device 212 comprises a receive antenna 213, a power amplifier 214 and a downconverter 215.

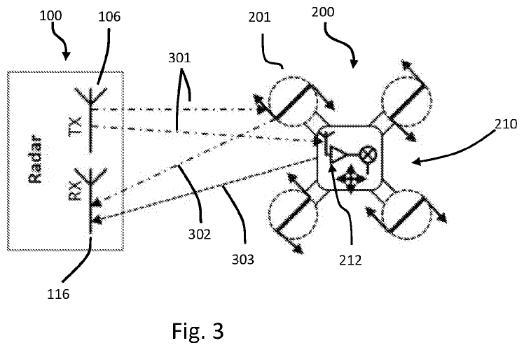

FIG. 3 is a schematic diagram of the radar apparatus 100 in use transmitting a predetermined signal 301 (represented using a dash-dot line style in the drawings) from the radar transmit antenna 106 towards drone 200. The predetermined signal 301 is a Continuous Wave (CW) signal with a centre frequency F₁ of 2.4 GHz and a high EIRP (sufficient to saturate the wireless communication device 212 within a reasonable range of the radar 100). The signal 301 is reflected off the rotor blades 201 and the body 210 to provide a skin return 302 which is received by the radar receive antenna 116. In addition, the signal 301 is received by the onboard wireless communication device 212 through the antenna 213. The signal 301 is in-band of the device 212 and causes the amplifier 214 to saturate creating a re-radiated signal 303 (represented using a dashed line style in the drawings) comprising a rich set of harmonics which are substantially n integer multiples of the fundamental F₁. The re-radiated signal 303 is re-radiated out of the antenna 213. The radar 100 receives the re-radiated signal 303. The receiver 110 selects the harmonic of interest, converts to IF and directs the signal to the signal processor 102. The signal processor 102 analyses signal 303 to measure any frequency components (which may or may not be due to micro-Doppler components) on the harmonic. In this embodiment, the signal processor 102 comprises a database (not shown) of known micro-Doppler signatures from wireless communication devices in response to the predetermined signal 301 on a wide range of operational (vibrating) drones. The radar 100 declares a detection of a drone where the frequency components on the signal 303 sufficiently correlates with one or more of the micro-Doppler signatures in the database within a reasonable tolerance. The matching process involves cross-correlation of the signal 303 with the signatures in the database.

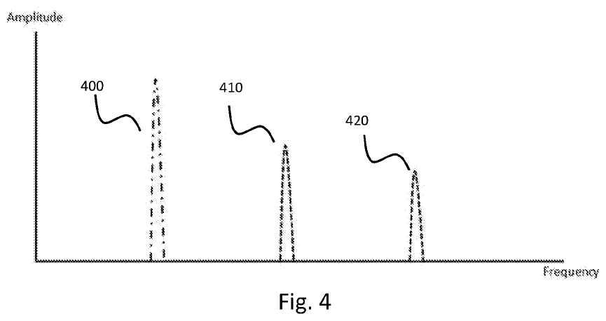

FIG. 4 shows the spectrum of the return signals from the drone 200 when illuminated by the predetermined signal 301. The skin return 302 has a fundamental frequency component 400, where n=1, with a centre frequency of substantially F₁. The re-radiated signal 303 comprises a first harmonic frequency component 410, where n=2, with a centre frequency F₂ of substantially 2×F₁. The re-radiated signal 303 further comprises a second harmonic frequency component 420, where n=3, with a centre frequency F₃ of substantially 3×F₁. In addition, the centre frequencies of each frequency component may each be shifted due to a bulk Doppler shift of the drone 200. The highest amplitude of the fundamental 400 is a function of the RCS of the drone 200 and is inversely proportional to range squared (R²). In contrast, the highest amplitudes of the first harmonic 410 and second harmonic 420 are a function of n, the gain of the antenna 213 and are inversely proportional to range to a power of 4 (R⁴).

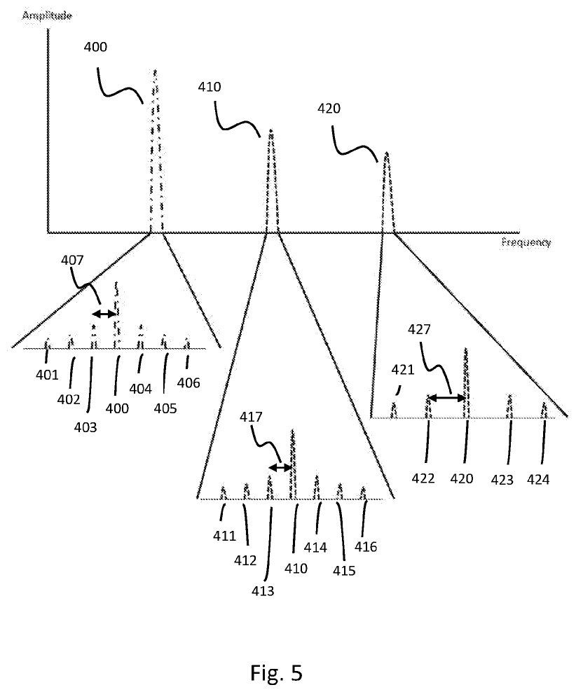

FIG. 5 illustrates that each frequency component of FIG. 4 comprises micro-Doppler components. The micro-Doppler components are particularly apparent when measured on a spectrum analyser using a narrow resolution bandwidth and a narrow frequency span centred on the centre frequency of the corresponding frequency component.

The micro-Doppler components of the fundamental 400 are a result of the rotation of the rotor blades 201 on the drone 200. The micro-Doppler component 403 is the return from a rotor blade 201 rotating towards the radar receiver 110. The component 403 therefore has a negative frequency shift relative to the fundamental 400 by an amount equal to the Doppler shift 407. The Doppler shift 407 is a function of the angular velocity of the blade 201 and the carrier frequency; in this case the carrier frequency is the fundamental frequency F₁ 400. Micro-Doppler components 402 and 401 are harmonics of component 403; the amplitude of the harmonics 402 and 401 are a function of the order (n) of the harmonic. The micro-Doppler component 404 is the return from a rotor blade 201 rotating away from the radar receiver 110. The component 404 therefore has a positive frequency shift relative to the fundamental 400 by an amount equal to the Doppler shift 407. Micro-Doppler components 405 and 406 are harmonics of component 404.

The micro-Doppler components of the first harmonic 410, second harmonic 420 and any n^{th} order harmonics (not shown) are a result of vibrational movement of the drone body 210 which may be related to the rotor blade 201 motion or other vibrating components on the drone 200. Vibrational movement typically results in an oscillating motion in several directions at a certain frequency. The frequency may be dependent on the speed of the rotor blades 201. The micro-Doppler components 413 and 414 are negative and positive (respectively) Doppler shifts of the first harmonic 410 due to this oscillating motion. Micro-Doppler components 412, 411, 415 and 416 are harmonics of components 413 and 414 respectively. The micro-Doppler components 422 and 423 are negative and positive (respectively) Doppler shifts of the second harmonic 420 due to this oscillating motion. Micro-Doppler components 421 and 424 are harmonics of components 422 and 423 respectively. Since Doppler is a function of the carrier frequency, the Doppler shift (and the separation between micro-Doppler components) increases with the harmonic order. For example, the Doppler shift of the second order harmonic 427 is greater than that of the first order harmonic 417.

It will be understood that the present invention has been described above purely by way of example, and modification of detail can be made within the scope of the invention.

Moreover, the invention has been described with specific reference to an active, monostatic, harmonic radar. It will be understood that this is not intended to be limiting and the invention may be used more generally. For example, the invention may be used more generally in bistatic, multistatic or even passive radars or other types of sensors. Additional applications of the invention will occur to the skilled person.

1. A computer implemented method of detecting a drone from a micro-Doppler signature, the method comprising the steps of controlling a computer processor to perform the steps of:
receiving signal data of a re-radiated signal from a wireless communication device on a drone following stimulation of the wireless communication device by a predetermined signal;
applying a detection operation to the re-radiated signal data to detect a micro-Doppler signature; wherein the detection operation comprises applying a predetermined criterion for distinguishing at least one known micro-Doppler signature of a wireless communication device on a drone, from at least one known signature of a wireless communication device that is not on a drone;
declaring the detection of a drone in response to a positive detection based on the predetermined criterion.
characterised in that:
the re-radiated signal comprises fundamental component and harmonic components; the frequency of the harmonic components being substantially N integer multiples of the fundamental component; wherein N is greater than 1;
the computer processor performs the further steps of:
extracting harmonic component data from the re-radiated signal data; and then
applying the detection operation to the harmonic component data.

2. The computer implemented method according to claim 1, wherein N is less than 10.

3. The computer implemented method according to claim 1, wherein the detection operation comprises correlating a detected micro-Doppler signature with a database comprising known micro-Doppler signatures.

4. The computer implemented method according to claim 1, wherein the detection operation comprises correlating detected micro-Doppler signatures across a plurality of harmonic components.

5. The computer implemented method according to claim 1, wherein the computer processor is further configured to classify the drone.

6. The computer implemented method according to claim 1, wherein the computer processor is further configured to identify the drone.

7. The computer implemented method according to claim 1, wherein the wireless communication device is a wireless network based on the Institute of Electrical and Electronics Engineers IEEE 802.11 family of standards.

8. The computer implemented method according to claim 1, wherein the centre frequency of the predetermined signal is within the 2.4 GHz ISM band.

9. A radar apparatus comprising means for carrying out the method of claim 1.

10. A data processing apparatus comprising means for carrying out the method of claim 1.

11. A computer program comprising instructions which, when the program is executed by a computer, cause the computer to carry out the method of claim 1.

12. A computer-readable medium having stored thereon the computer program of claim 10.
